(19) United States
(12) Patent Application Publication
(10) Pub. No.: US 2002/0006308 A1
(43) Pub. Date: Jan. 17, 2002

(54) Systems and methods for securing a covering against a surface

(76) Inventor: Behzad Maleken, Norwood, MA (US)

Correspondence Address: FOLEY, HOAG & ELIOT, LLP, PATENT GROUP, ONE POST OFFICE SQUARE, BOSTON, MA, 02109, US

(21) Appl. No.: 09/732,853

(22) Filed: Dec. 8, 2000

Related U.S. Application Data
(60) Provisional application No. 60/170,152, filed on Dec. 10, 1999.

(51) Int. Cl. F16B 7/08; F16B 9/00; F16L 41/00

(52) U.S. Cl. 403/188

(57) ABSTRACT

A system for securing a covering against a surface is provided. The system includes an elongated rod, adjustable along its length, for placement over a covering. The system also includes a mounting assembly to be secured to a surface against which the covering is placed, such that the rod may be coupled to the assembly. A method for securing a covering against a surface is also provided.

### RELATED U.S. APPLICATION(S)

This application claims priority to U.S. Provisional Application Ser. No. 60/170,152, filed Dec. 10, 1999, which application is hereby incorporated herein by reference.

### TECHNICAL FIELD

The present invention relates generally to systems and methods for securing a covering against a surface, and more specifically, to systems and methods which can be adjusted according to the width and thickness of the covering to securely fix the covering against a surface.

### BACKGROUND ART

Currently available systems for securing a covering against a surface, such as stair rods used in securing a rug to the stairs, are designed for to accommodate covering of a fixed size. In particular, during installation, each rod must be custom cut to fit the width of the rug. Once the rod is cut, it cannot be later used with a covering having a larger width.

In addition, because of the differences in the thickness of each covering, such as a rug, different size brackets must be used to secure the covering between the rods and the surface on which the covering is placed. Presently, to adjust for the differences in the thickness of the covering, different brackets shims must placed under each bracket, between the surface and the bracket, to permit each bracket to be fixed against the surface, while providing the rug with sufficient clearance between the rod and the surface.

Accordingly, it is desirable to provide a system which permits adjustments to accommodate coverings of different sizes and/or of varying thickness.

### SUMMARY OF THE INVENTION

The present invention provides, in one embodiment, a system for securing a covering against a surface. The system includes an elongated rod, adjustable along its length, for placement over the covering. In one embodiment, the rod includes a first member slidably received within the second member. The system also includes a mounting assembly to be secured to the surface on which the covering is placed, such that the rod may be coupled thereto. The mounting assembly, in an embodiment, includes at least two brackets, each designed to receive one of the first and second members. The coupling of the rod to the mounting assembly permits the covering to be securely retained against the surface.

In accordance with another embodiment, the present invention provides a method for securing a covering against a surface. The method includes providing a system having an elongated rod that is adjustable along its length, and a mounting assembly to be secured to the surface on which the covering is placed. Next, the mounting assembly may be secured to the surface. Subsequently, the covering may be placed against the surface and adjacent to the mounting assembly. Thereafter, the elongated rod may be positioned over the covering and the rod coupled to the mounting assembly.

The present invention further provides a mounting assembly for receiving an elongated rod used in securing a covering against a surface. The assembly includes, in one embodiment, a bracket having body with a first and a second end, and a leg at each of the first and second end. The legs may be pointing in a direction generally away from the body. The assembly also includes a support positioned on the body and substantially perpendicular thereto for engaging a rod. The support permits the rod to slidably move in a direction substantially perpendicular to the body, so as to allow the assembly to accommodate coverings of different thicknesses.

### BRIEF DESCRIPTION OF THE DRAWINGS

FIG. 1 shows, in accordance with an embodiment of the present invention, a detailed illustrations of the components of the system for securing a covering against a surface.

FIG. 2 illustrates the relative position of the major components of the system with respect to one another.

FIG. 3 illustrates a mounting assembly for use in the system shown in FIGS. 1-2.

FIG. 4 illustrates a mounting assembly, in accordance with another embodiment of the present invention, for use in the system shown in FIGS. 1-2.

### DESCRIPTION OF THE PRESENT INVENTION

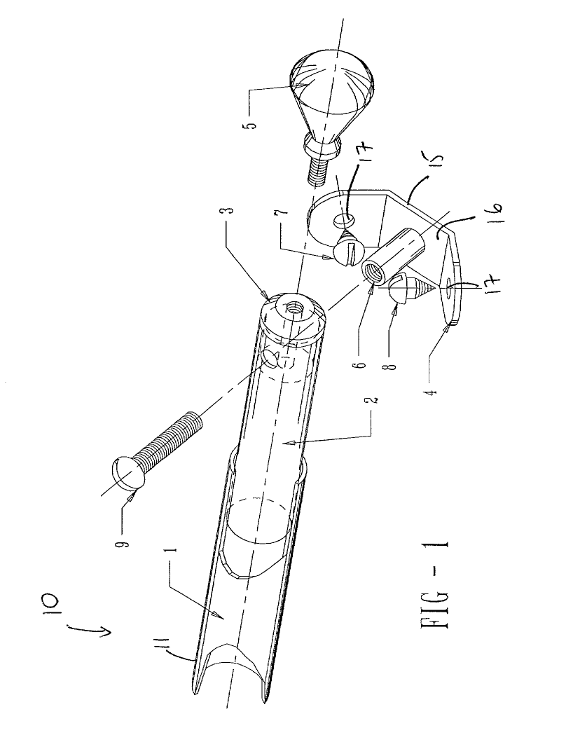

The present invention provides a system which can securely accommodate coverings of various sizes and thickness. In one embodiment, as shown in FIG. 1, the system 10 is provided with an elongated rod 11 that is extendable along its length, and a mounting assembly 15, which permits the rod 11 to slidably engage the mounting assembly 15 in a direction substantially perpendicular to the direction of extension of the rod 11.

As shown in FIG. 1, the rod 11 includes a first member 2 configured to be slidably received within a second member 1. In this manner, the rod 11 may be adjusted along its length to accommodate coverings of different widths. The first member 1 and second member 2, in one embodiment, may be cylindrical in shape. Although shown to be cylindrical in shape, the members may include any geometric profile, for instance, square, hexagonal, or octagonal, so long as the members can slidably engage one another, while still be capable of securing a covering against a surface.

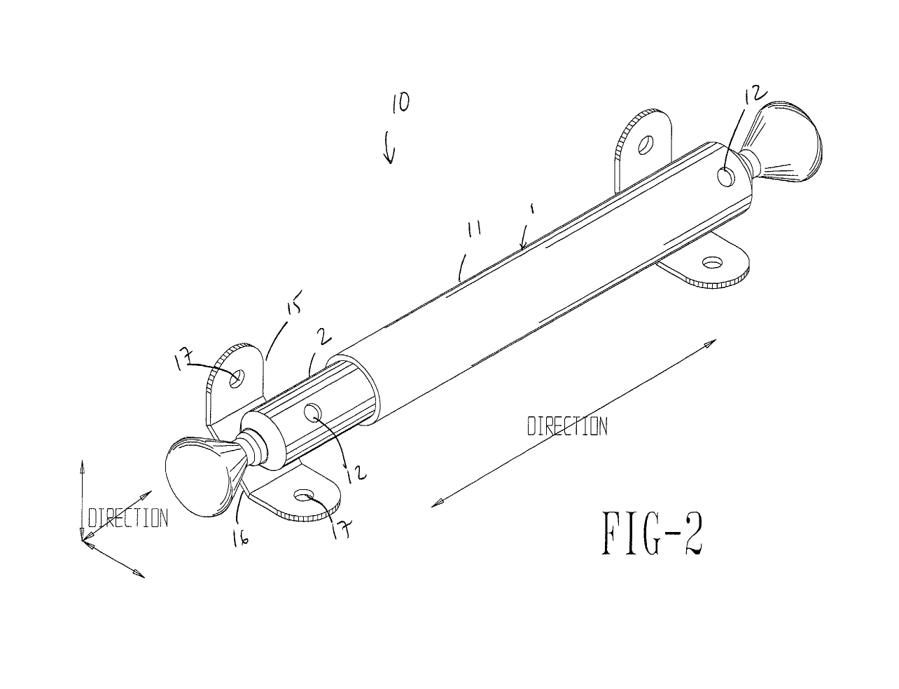

Referring now to FIG. 2, each of the first member 1 and second member 2 may be provided, in one embodiment, with an aperture 12 at an end opposite where the first and second members are engaged. The presence of aperture 12 on each of the members permits the rod 11 to be securely coupled to the mounting assembly 15.

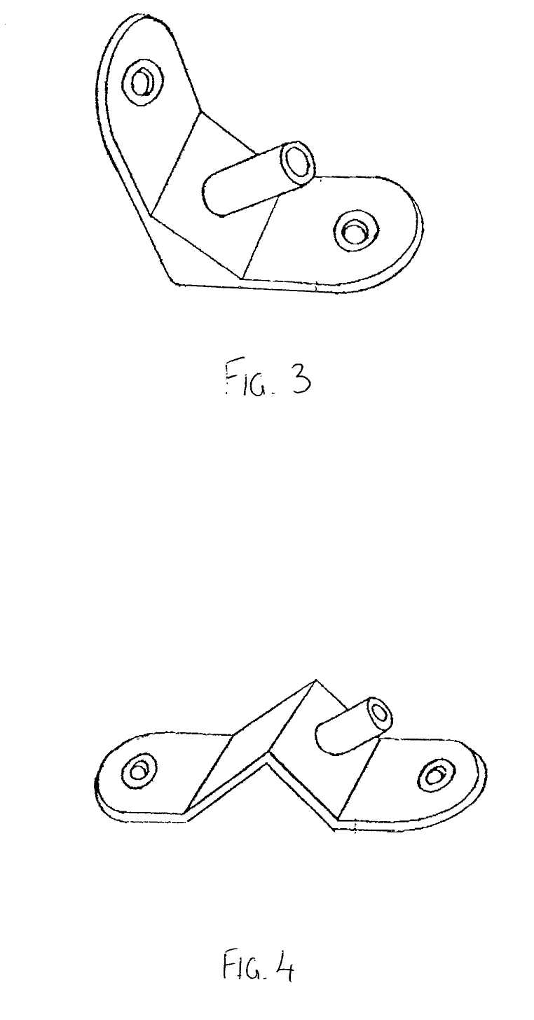

Looking again at FIG. 1, the mounting assembly 15, in one embodiment, may include a bracket that is provided with a body portion 16 having a first end 13 and a second end 14, and a leg 4 at each of the first end 13 and second 14. As shown in FIG. 1, the legs 4 can be positioned on a same side of the body portion 16, so that the legs 14 point in a direction generally away from the body portion 16. In one embodiment, the legs 4 are at an angle to the body portion 16 to permit the bracket to be secured against two surfaces that are at substantially right angle to one another, such as conventional stairs. To permit the mounting assembly 15 to fit securely within a juncture between the two surfaces that are at substantially right angle to one another, the body portion 16 of the assembly 15 may be provided an angular projection 161, as shown in FIG. 3, conforming to the substantially right angle between the two surfaces. If the system 10 is used, for example to secure a covering, such as a comforter or rug, against a flat surface, such as a wall, looking now at FIG. 4, the legs 4 may be positioned substantially in a same plane with the body portion 16, such that the legs 4 and the body portion 16 share a common axis. In addition, the body portion 16 may be elevated, for instance, away from the surface against which the covering may be placed to facilitate an engagement between the rod 11 and the mounting assembly 15. As illustrated in FIGS. 1-4, each of the legs 4 may be provided with a hole 17 for receiving a screw 7 or 8 to permit securing of the mounting assembly 15 against the surface. In a preferred embodiment, the mounting assembly 15 may include a plurality of brackets to permit secured placement of a covering against a surface.

The mounting assembly 15 further includes a support 6 that is positioned on the body portion 16 for engaging the elongated rod 11. The support 6, in the embodiment shown in FIGS. 1-3 may be substantially perpendicular to the body portion 16. Such a configuration, however, may not be a necessary requirement. As shown in FIG. 4, the support 6 may be substantially perpendicular to a segment of the body portion 16. The support 6, in an embodiment, may be a substantially cylindrical member having a diameter that permits the support 6 to extend through the aperture 12 in each of the first member 1 and second member 2 of the rod 11. By providing the support 6 with such an engagement through the rod 11, the rod 11 may be allowed to slidably move in a direction substantially perpendicularly to the body portion 16 (i.e., along the body portion 16), so as to allow the system 10 to accommodate coverings of different thickness. It should be appreciated that the support 6 and the aperture 12 are provided with complementary profiles, so that the may engage one another. In this respect, the support 6 and the aperture 12 may be provided with any geometrical profile, so long as the support 6 is capable of extending through the aperture 12.

The cylindrical support 6 may be threaded along its interior surface, as shown in FIG. 1, to receive a tightening screw 9. By tightening the screw 9 within the interior surface of the cylindrical support 6, the rod 11 may be securely fixed to the mounting assembly 15. Although the support 6 is shown with a threaded interior surface, it should be appreciated that the support 6 may be configured with other means for securing the rod 11 to the mounting assembly 15, so long as the support 6 is capable of receiving each of the members of the rod 11 through aperture 12.

As shown in FIG. 2, the system 10, in one embodiment, can include a decorative piece 5, designed to be positioned at an end of each member 1 and member 2 adjacent the aperture 17.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

What is claimed is:

1. A system for securing a covering against a surface, the system comprising:
an elongated rod, adjustable along its length, to be positioned over the covering;
a mounting assembly to be secured to the surface, such that the rod may be coupled thereto;
wherein coupling of the rod to the mounting assembly permits the covering to be securely retained against the surface.

2. A system as set forth in claim 1, wherein the rod includes a first member slidably received within a second member.

3. A system as set forth in claim 2, wherein each of the first and second member is configured to retain an ornamental piece at an end opposite where the first and second member are engaged.

4. A system as set forth in claim 2, wherein the mounting assembly includes at least two brackets, each bracket designed to adjustably receive one of the first and second members.

5. A system as set forth in claim 4, wherein each bracket includes a body to which a support is positioned thereon, the support permitting each of the first and second members to slidably engage along the support so as to allow the system to accommodate covering of different thickness.

6. A method for securing a covering against a surface, the method comprising:
providing a system having an elongated rod adjustable along its length to be positioned over the covering and a mounting assembly to be secured to the surface such that the rod may be coupled thereto;
securing the mounting assembly to the surface against which the covering is to be retained;
placing covering against the surface and adjacent to the mounting assembly;
positioning the elongated rod over the covering; and
coupling the rod to the mounting assembly.

7. A method as set forth in claim 6, wherein the step of providing includes providing the elongated rod with a first member slidably received within a second member.

8. A method as set forth in claim 7, wherein in the step of providing includes placing an ornamental piece on each of the first and second members at an end opposite where the first and second member are engaged.

9. A system as set forth in claim 7, wherein the step of providing includes providing the mounting assembly with at least two brackets, each bracket designed to adjustably receive one of the first and second members.

10. A system as set forth in claim 9, wherein in the step of coupling, each bracket is provided with a body to which a support is positioned thereon, the support permitting each of the first and second members to slidably engage along the support so as to allow the system to accommodate coverings of different thickness.

11. A mounting assembly for receiving an elongated rod, the assembly comprising:
a plurality of brackets, each bracket having:
a body having a first and second end; and
a leg at each of the first and second end on a same side of the body and pointing in a direction generally away from the body; and
a support positioned on the body for engaging the rod, the support permitting the rod to slidably move in a direction substantially perpendicular to the body, so as to allow the system to accommodate coverings of different thickness.
